(19) United States
(12) Patent Application Publication
(10) Pub. No.: US 2024/0143296 A1
(43) Pub. Date: May 2, 2024

(54) METHODS AND APPARATUS FOR COMBINING CODE LARGE LANGUAGE MODELS (LLMs) WITH COMPILERS

(71) Applicant: Intel Corporation, Santa Clara, CA (US)

(72) Inventor: Niranjan Hasabnis, San Jose, CA (US)

(21) Appl. No.: 18/393,473

(22) Filed: Dec. 21, 2023

(51) Int. Cl. G06F 8/41

(52) U.S. Cl. CPC G06F 8/41

(57) ABSTRACT

Example apparatus disclosed includes interface circuitry, machine readable instructions, and programmable circuitry to at least one of instantiate or execute the machine readable instructions to receive an input source code by a code large language model (LLM), generate one or more code representations of the input source code, analyze the one or more code representations of the input source code, and compile the one or more code representations of the input source code into one or more computer executable instructions.

### FIELD OF THE DISCLOSURE

This disclosure relates generally to software processing, and, more particularly, to methods and apparatus for combining code large language models (LLMs) with compilers.

### BACKGROUND

Large Language Models (LLMs) incorporate artificial intelligence algorithms that work in concert with neural network techniques using an extensive number of parameters to interpret and generate computer-based code. Code snippets or complete programs are generated using LLMs based on input instructions. As such, code writing efficiency can be improved using LLM-based autocompletion and code generation.

### BRIEF DESCRIPTION OF THE DRAWINGS

FIG. 1 illustrates example components of a compiler, including different program representations.

FIG. 2 illustrates example deployment of a large language model (LLM) as a code editor plugin.

FIG. 3 illustrates an example database of mappings between an input program and a corresponding program representation of interest (e.g., abstract syntax tree (AST)).

FIG. 4 illustrates mappings between different program elements and their subtrees in an abstract syntax tree (AST).

FIG. 5 illustrates an example deployment phase with an end-to-end scenario of a search over the database, including an example code evaluator circuitry.

FIG. 6 illustrates an example serial program and a parallel version suggested by ChatGPT™.

FIG. 7 illustrates an example output of the serial program of FIG. 6, including outputs of the ChatGPT™ parallel program and output of a serial program parallelized by a GNU Compiler Collection (GCC) compiler auto-parallelization.

FIG. 8 is a block diagram representative of the code compiler circuitry that may be implemented in the example environment of FIG. 5.

FIG. 9 is a flowchart representative of example machine-readable instructions and/or example operations that may be executed, instantiated, and/or performed by example programmable circuitry to implement the example code compiler circuitry of FIG. 8.

FIG. 10 is a flowchart representative of example machine-readable instructions and/or example operations that may be executed, instantiated, and/or performed by example programmable circuitry to implement the example code compiler circuitry of FIG. 8 to perform training using identified code representation(s).

FIG. 11 is a flowchart representative of example machine-readable instructions and/or example operations that may be executed, instantiated, and/or performed by example programmable circuitry to implement the example code compiler circuitry of FIG. 8 to search over database mappings using input code.

FIG. 12 is a block diagram of an example processing platform including programmable circuitry structured to execute, instantiate, and/or perform the example machine readable instructions and/or perform the example operations of FIGS. 9-11 to implement the code compiler circuitry of FIG. 8.

FIG. 13 is a block diagram of an example implementation of the programmable circuitry of FIG. 12.

FIG. 14 is a block diagram of another example implementation of the programmable circuitry of FIG. 12.

FIG. 15 is a block diagram of an example software/firmware/instructions distribution platform (e.g., one or more servers) to distribute software, instructions, and/or firmware (e.g., corresponding to the example machine readable instructions of FIGS. 9-11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Code Large Language Models (LLMs), such as OpenAI Codex™ or ChatGPT™, represent deep learning algorithms that can be used to recognize, summarize, predict, and/or generate content using large datasets. Use of LLMs permits artificial intelligence (AI)-based models to generate human-like content. For example, starting from relatively simpler problems of predicting a subsequent program token (e.g., in code completion), code LLMs are used to address more complex problems, such as code generation and code translation, among others. These code LLMs are deployed as programming assistant technologies via plugins to popular code editors (e.g., such as Visual Studio Code). However, while code LLMs can solve simpler programming problems such as code completion, code LLMs do not solve complex programming problems that require program reasoning capabilities. Compilers, on the other hand, do possess program reasoning capabilities but cannot analyze incomplete programs (i.e., programs that cannot be compiled). Alternatively, code LLMs (e.g., GitHub CoPilot) can handle incomplete programs (e.g., as a plugin to code editors). In methods and apparatus disclosed herein, program reasoning capabilities of code LLMs can be improved through use in tandem with a compiler, allowing code LLMs to solve complex programming problems when deployed in code editors (e.g., as a plugin).

Natural language LLMs do not possess logical and mathematical reasoning skills. Known approaches based on improved prompt engineering have attempted to introduce such reasoning skills. Such approaches include Chain of Thought (CoT) prompting and Least to Most (LtM) prompting, where CoT prompting provides several intermediate reasoning rationales to an LLM along with the original prompt. LtM prompting takes a step further than CoT prompting by breaking the problem into subproblems and providing an LLM with answers to those subproblems, thereby teaching an LLM to break the problems into subproblems and solve those subproblems. Borrowing from natural language LLMs, most initial code LLMs were mostly representing programs as sequences of tokens for input to underlying AI models. Realizing that programs have certain structure, several recent code LLMs (e.g., PolyCoder, CodeT5+, etc.) have proposed using various typical program representations (e.g., such as abstract-syntax tree (AST) and control-flow graph (CFG)) along with, and/or instead of, a sequence of tokens. These program representations improve upon the use of a sequence of tokens representation by capturing some underlying program properties (e.g., such as data-flow information, control-flow information, etc.).

However, prompt engineering-based techniques for improving the reasoning skills of natural language LLMs are based on manual approaches. Likewise, it remains unclear as to how easily prompt engineering-based techniques can scale to different types of problems for code LLMs. For instance, code parallelization problems rely on loop-carried dependence information, which first needs to be extracted for a given input program. As such, LLMs first need to extract this information before processing the information for reasoning, which is conceptually connected to reinventing what compilers do best. Furthermore, existing code LLMs that use compiler-based program representations cannot reason about programs, since program representations provide for just one component of the reasoning process. However, the reasoning process also involves program analysis passes that compilers contain, but existing code LLMs are not trained to perform such program analyses.

Methods and apparatus disclosed herein combine code LLMs with compilers. In examples disclosed herein, program reasoning capabilities are added to code LLMs. For example, compilers can already reason about various program properties formally by employing different program representations such as AST, CFG, and data-flow graph (DFG), among others. Unlike code LLMs, compilers cannot reason about incomplete programs because such programs cannot be parsed and hence these code representations cannot be generated for incomplete programs. Accordingly, compilers cannot be deployed in code editors where the code under development is uncompilable. In examples disclosed herein, merging LLMs with compilers takes advantage of the strengths of each while eliminating the existing weaknesses. Furthermore, methods and apparatus disclosed herein can be deployed as a part of a software suite or as a standalone Software-as-a-Service (SaaS) model (e.g., optimization-as-a-service) to assist developers with complex problems. For example, software developers do not know how to get the best performance from specific hardware (e.g., such as Xeon CPUs), but engineers can optimize software to deliver significant performance improvements. Existing code LLMs cannot assist in such cases because code optimization is a complex problem (where code parallelization is a subproblem) that requires program reasoning capabilities. Methods and apparatus disclosed herein enable code LLMs to solve complex programming problems and improve overall programming efficiency.

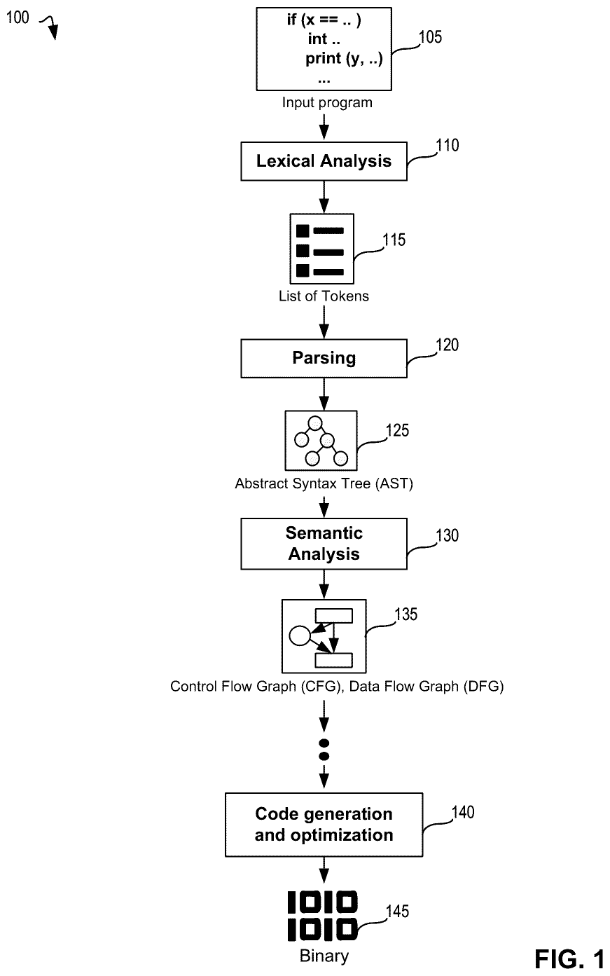

FIG. 1 illustrates example components 100 of a compiler, including different program representations. Compilers perform reasoning by using various program representations, including abstract-syntax tree (AST), control-flow graph (CFG), and/or data-flow graph (DFG). The program representations enable different passes to reason about various program properties. Different program representations contain different types of program information that are used by compiler-based analysis/transformation passes. As such, a specific program representation coupled with a specific analysis pass enables compilers to reason about programs. For example, optimization passes, such as dead-code elimination (DCE), rely on control-flow graph(s) (CFG) and data-flow graph(s) (DFG) to determine whether an assignment statement is reachable. For example, reachability analysis relies on control-flow information that is captured in a CFG. In the context of code parallelization, loop-carried dependence is the key information that enables the parallelization pass (e.g., LLVM's LoopAccessAnalysis pass) to decide if a loop can be parallelized.

In the example of FIG. 1, an input program 105 is passed to lexical analysis 110, which represents the first phase of a compiler, converting high level input into a sequence of tokens 115, where a lexical token is a sequence of characters that can be treated as a unit in the grammar of a programming language. Tokens can include type tokens, punctuation tokens, and/or alphabetic tokens. Output from the sequence of tokens 115 can be sent to an example parser to perform parsing 120 for syntax analysis. In the example of FIG. 1, syntax analysis is performed using abstract syntax trees (ASTs) 125, which represent the structure of program code. The AST serves as a representation of the abstract syntactic structure of text (e.g., source code) written in a formal language, such that each node of the tree denotes a construct occurring in the text. The AST is passed to example semantic analysis 130, which uses the syntax tree and a symbol table to determine whether a given program is semantically consistent with a language definition. An example control flow graph (CFG) and/or data flow graph (DFG) 135 is generated, where data flow considers the source, destination, and/or data transformations. For example, the CFG is a representation of all paths that might be traversed through a program during execution, while the DFG is a representation of data flow through a program (e.g., identifying variables that hold values at different points in the program, etc.). Outputs of the CFG and DFG-based analyses are used for example code generation and optimization 140, resulting in an example binary output 145.

Unlike code completion, complex programming tasks require a more complicated approach. For instance, code parallelization demands correct program reasoning based on loop-carried dependence information. Current techniques such as a GPT-3.5 model (e.g., via ChatGPT™) can be tried for parallelizing a simple for loop written in C programming language. However, while a program such as ChatGPT™ can analyze simpler cases correctly and answer that the loop can or cannot be parallelized, more complicated cases render incorrect answers. For example, when presented with the code below, ChatGPT™ correctly answers that the loop cannot be parallelized:
. . . int a[10];
   for (int i=0; i<10; i++)
      a[i]=a[i−1]; . . . .

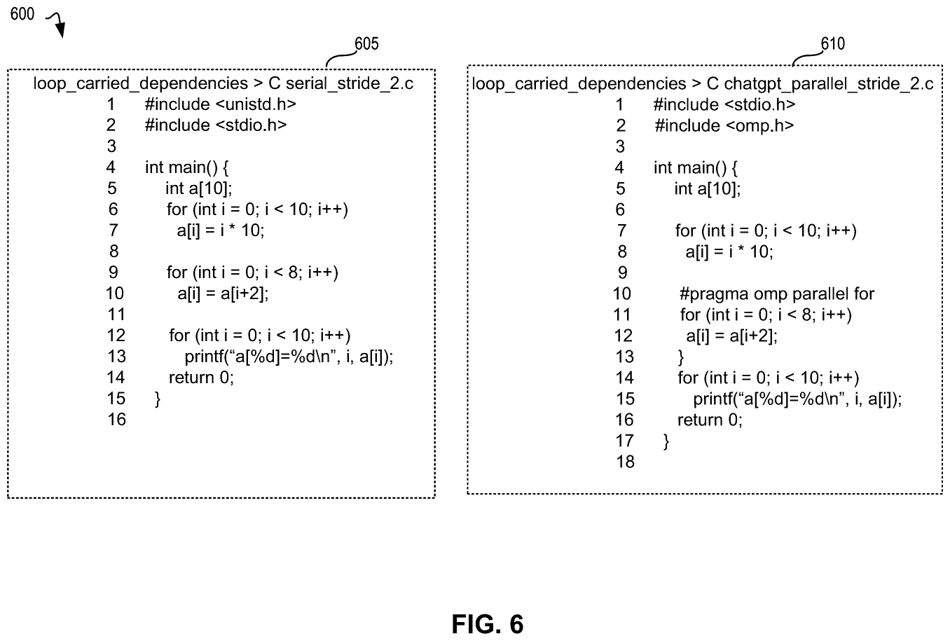

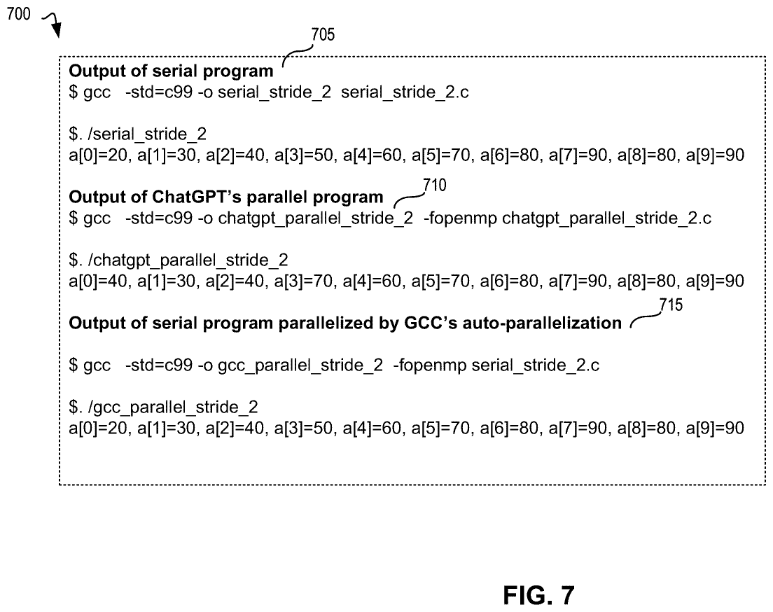

The reason why the loop above cannot be parallelized is because it has backward loop-carried dependence, such that a current iteration of the loop depends on the previous iteration. However, when presented with the code shown below and asked whether the code can be parallelized, ChatGPT™ provides an incorrect answer (e.g., an incorrectly parallelized version of a loop, as shown in more detail in connection with FIGS. 6 and 7):
. . . int a[10];
   for (int i=0; i<8; i++)
      a[i]=a[i+2]; . . . .

Specifically, the above example is more complicated because although the program has loop-carried dependence (e.g., the same reason why the first loop above cannot be parallelized), the loop dependence distance in the second example is 2 (e.g., a[i]=a[i+2]), and therefore the loop can be parallelized. However, a parallelized version of ChatGPT™ (e.g., as shown in connection with FIGS. 6-7) is incorrect (e.g., the correct parallelization analyzes that the consecutive elements a[i] and a[i+1] can be processed in parallel), as described in more detail in connection with FIG. 6. As such, existing code LLMs cannot reason about programs and are not successful when presented with complex programming tasks. For example, there are currently no known code LLMs that can perform program reasoning using compilers to solve complex programming problems. In examples disclosed herein, enabling code LLMs to perform program reasoning can be based on the observation that compilers already possess these capabilities and that code LLMs can build on those capabilities from compilers.

Generally, code LLMs do not possess program reasoning capabilities because code LLMs are not designed to reason about programs specifically. Instead, code LLMs are trained on pairs of input program(s), output program(s) and/or label(s) and are asked to learn the mapping function that produces the output program and/or label for a given input program (e.g., output program for code translation problem, label for code classification problem, etc.). As such, code LLMs are asked to learn the appropriate program representations along with the appropriate code analysis passes to solve a specific programming problem. Most code LLMs typically represent input programs as a sequence of tokens. In some examples, LLMs use basic program representations such as abstract-syntax tree (e.g., AST), as shown in connection with FIG. 1. However, these basic representations are not enough to perform complex program analysis. For example, complex analysis passes occur later in the compilation process and are beyond the reach of current LLMs. However, LLMs also have inherent benefits, such as acting as programmer-assistance technologies by operating as plugins in code editors (e.g., such as Visual Studio Code). In such scenarios, the code is usually under development and is not compilable. As a result, sophisticated compiler passes (e.g., such as a LoopAccess analysis pass) are not operable in such examples. However, LLMs can operate on such uncompilable code and improve programmers' productivity by providing assistance. In examples disclosed herein, program reasoning capabilities are added to code LLMs, allowing code LLMs to reason about programs by combining existing strengths of compilers as well as LLMs. In examples disclosed herein, LLMs generate compiler-required program representations from incomplete programs, drawing upon the strength of code LLMs in handling incomplete programs. Likewise, existing program reasoning capabilities of compilers can be leveraged by applying compilers on the program representations, drawing upon the existing strengths of compilers in program analysis.

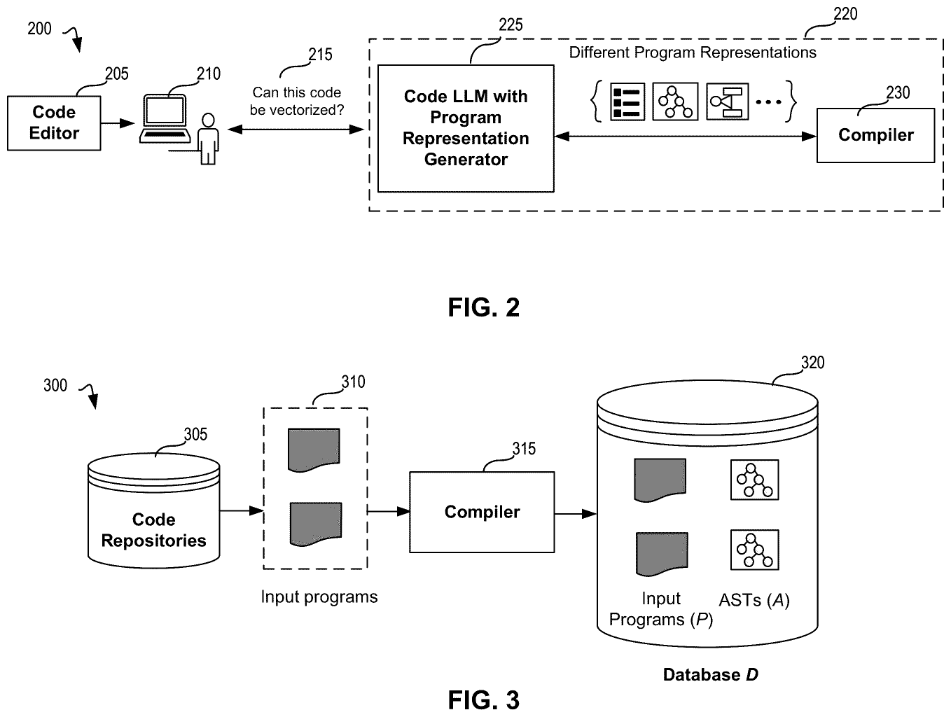

FIG. 2 illustrates example deployment 200 of a code LLM as a code editor plugin. In the example of FIG. 2, a code LLM with program reasoning capabilities is deployed as a plugin to a code editor 205. For example, when a programmer 210 is writing code, the plugin can ask whether the code can be vectorized, at 215. The code LLM's program representation generator 225 then processes the uncompilable code to generate its representation and feed the representation to a compiler 230 to run analysis passes on that representation and answer the given question (e.g., “Can the code can be vectorized?”). The specific program representation generated by the generator can vary depending on the question. For example, for a question concerning code vectorization, the representation would be a data flow graph (DFG), while for a question concerning code parallelization, the representation would be loop-carried dependence information. As such, an example group of possible program representations 220 is shown in FIG. 2 as being open-ended. The generated program representations are fed to compiler 230 for the compilation process, as illustrated in connection with FIG. 1.

FIG. 3 illustrates an example database of mappings 300 between an input program and a corresponding program representation of interest (e.g., abstract syntax tree (AST)). In the example of FIG. 3, a database of code repositories 305 is used to generate input program(s) 310 which are compiled using compiler 315, with the input programs (P) 310 and their corresponding ASTs (e.g., program representations A) stored in database (D) 320. As described in connection with FIG. 2, the program representation generator 225 generates a program representation for uncompilable code. In the example of FIG. 3, the AST is used as the program representation to be generated by the program representation generator 225. However, methods and apparatus disclosed herein can be applied to any representation used by compilers (e.g., such as CFG, DFG, loop-carried dependencies, etc.).

While in the example of FIG. 3 the database mappings illustrate the use of an AST as the program representation of interest, any other type of program representation can be generated. The program representation generator 225 focuses on the following: (1) compiling the database of mappings between input source code/programs and their corresponding program representation of interest, (2) storing the mapping between individual source code elements and their sub-representations in the program representation of interest, and (3) searching over the database using the input code snippets to obtain the program representation of interest. The compiling and storing are part of the pre-deployment phase, while the searching is a part of the actual deployment phase. The goal of compiling is to build a database of programs written in a high-level language of interest and corresponding program representations of interest. For instance, the database (D) 320 can include mappings between the input program (P) and ASTs (A). For example, the database is the set of pairs of P, A, where P represents an input program and A represents the program representation (i.e., input {(P, A)}). A list of programs from open-sources and/or closed-sources can be gathered and compiled using a standard compiler (e.g., compiler 315), as shown in connection with FIG. 3. For example, standard compilers offer options to remove all the intermediate representations.

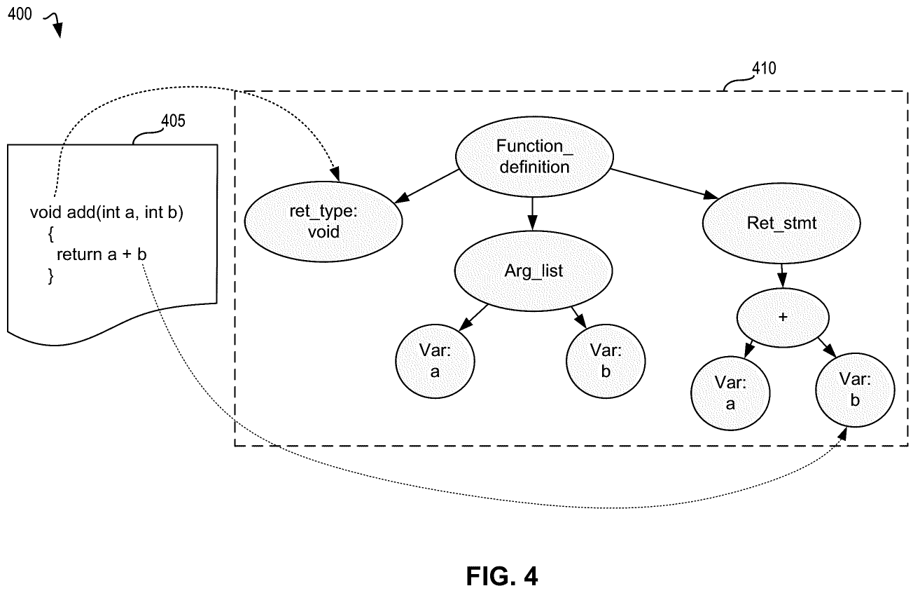

FIG. 4 illustrates example mappings 400 between different program elements and their program representations using an abstract syntax tree (AST). In the example of FIG. 4, storing of the mapping between individual source code elements (P) and their subtrees (A) in the program AST is shown. FIG. 4 includes program elements 405 and their subtrees in an AST 410, where the dotted lines indicate mappings. A source code element (P) represents different parts of a program (e.g., functions, loops, statements, variables, etc.). This aspect is needed because the actual input to an LLM is typically not a complete program, but instead, the input is in snippets of a complete program (e.g., such as a for loop). One preferred approach to obtain the mapping information is to use debugging information generated by the compiler of FIG. 3. Debugging information contains the mapping between locations in the input program and the corresponding program representations (e.g., shown using dotted lines in FIG. 4). The mapping between elements of P and their subtrees in A is stored in database D. In addition to the mapping between actual strings for elements of P and their subtrees in A, canonicalized versions of those elements are also stored together with their subtrees in A. For example, canonicalized versions enable a broader search when searching over the database D using input code snippets to obtain ASTs (e.g., in cases when the exact search is not successful).

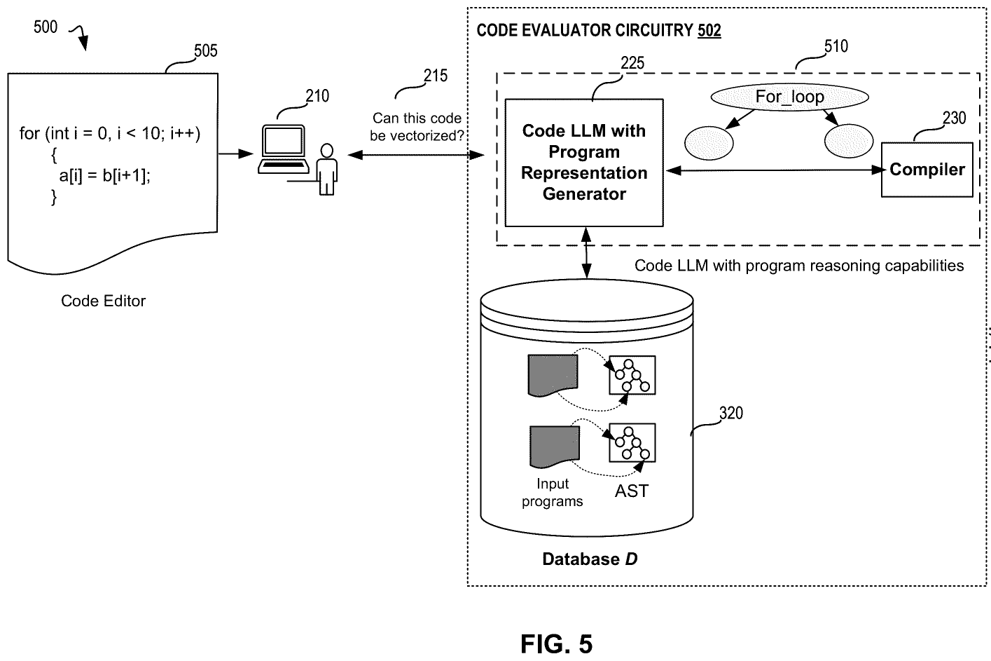

FIG. 5 illustrates an example deployment phase 500 with an end-to-end scenario of a search over the database D, including an example code evaluator circuitry 502. For example, FIG. 5 shows example searching over the database D 320 using an input code snippet to obtain an AST. As described in connection with FIG. 4, compilation of the database D 320 concludes the pre-deployment phase. During actual deployment, the code evaluator circuitry 502 uses the database D 320 for serving search queries. For example, given an input code snippet to an LLM (e.g., from the code editor 505), the LLM passes that snippet to the code LLM with program representation generator 225 to generate ASTs as the program representations. The code evaluator circuitry 502 uses the generator 225 to run searches for the snippet in D, and if found, returns its subtree by following the mapping generated in connection with FIG. 4. As previously described, the actual input to an LLM is typically not a complete program, but instead the input is in snippets of a complete program (e.g., such as a for loop 510). In case an exact snippet match fails, the code evaluator circuitry 502 can canonicalize the snippet by abstracting out extra details (e.g., such as variable names, constants, etc.). The returned subtree of an AST is then sent to the compiler 230 to run its analysis passes on the subtree. Although such subtrees may not represent complete ASTs of a program, conservative analysis passes along with soundness guarantees of compilers can handle analysis of such subtrees. For instance, for the input program shown in connection with FIG. 5, the compiler 230 output can be as follows: “The code can be parallelized if a and b are different arrays (non-aliased), but it cannot be parallelized if a and b are aliased.” Since the code shown in connection with FIG. 5 is not complete, compiler 230 does not have enough information about a and b to suggest a concrete outcome, but compilers are known to perform such conservative analyses.

FIG. 6 illustrates example code 600 of a serial program 605 and a parallel version 610 of the serial program suggested by ChatGPT™. In the example of FIG. 6, the serial program 605 and the parallel version 610 were compiled using a standard compiler (e.g., GNU Compiler Collection (GCC)) and the outputs were checked, showing that the output of the parallel version 610 suggested by ChatGPT™ was incorrect while the output of the serial program 605 was correct.

FIG. 7 illustrates an example code output 705 related to the serial program 605 of FIG. 6, including example output 710 associated with a parallel program of ChatGPT™ and example output 715 of a serial program parallelized by a GNU Compiler Collection (GCC) compiler auto-parallelization. As a formal program analysis-based comparison, GCC's auto-parallelization pass was used to generate a parallel version of the serial program 605, where the output of GCC's parallelized version was shown to be correct. As such, the methods and apparatus disclosed herein permit for the combination of compiler-based methods with LLMs to add program reasoning capabilities to code LLMs.

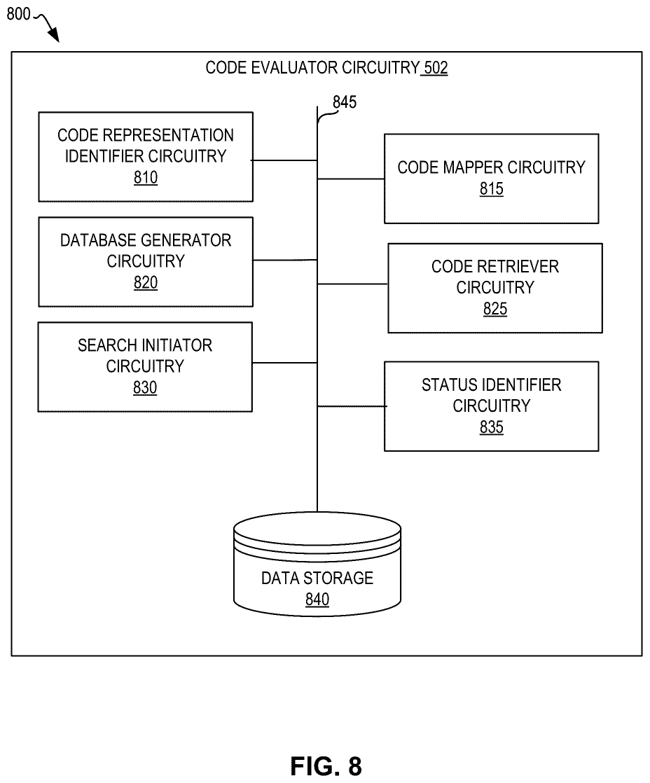

FIG. 8 is a block diagram of an example implementation of the code evaluator circuitry 502 of FIG. 5. The code evaluator circuitry 502 of FIG. 5 may be instantiated (e.g., creating an instance of, bring into being for any length of time, materialize, implement, etc.) by programmable circuitry such as a Central Processing Unit (CPU) executing first instructions. Additionally or alternatively, the code evaluator circuitry 502 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 8 may, thus, be instantiated at the same or different times. Some or all of the circuitry of FIG. 8 may be instantiated, for example, in one or more threads executing concurrently on hardware and/or in series on hardware. Moreover, in some examples, some or all of the circuitry of FIG. 8 may be implemented by microprocessor circuitry executing instructions and/or FPGA circuitry performing operations to implement one or more virtual machines and/or containers.

In the example of FIG. 8, the code evaluator circuitry 502 of FIG. 5 includes example code representation identifier circuitry 810, example code mapper circuitry 815, example database generator circuitry 820, example code retriever circuitry 825, example search initiator circuitry 830, example status identifier circuitry 835, and/or example data storage 840. In the example of FIG. 8, the code representation identifier circuitry 810, code mapper circuitry 815, database generator circuitry 820, code retriever circuitry 825, search initiator circuitry 830, status identifier circuitry 835, and/or data storage 840 are in communication via an example bus 845.

The code representation identifier circuitry 810 receives uncompilable code and identifies the type of compiler-based code representation to generate as part of identifying a representation of the uncompilable code. For example, the specific program representation can vary depending on the question posed by a programmer (e.g., is the code parallelizable, vectorizable, etc.). For code vectorization, the code representation identifier circuitry 810 identifies the representation as a data flow graph (DFG) representation. For code parallelization, the code representation identifier circuitry 810 identifies the representation as a loop-carried dependence representation. As such, the code representation identifier circuitry 810 identifies any type of representation that is appropriate for a given code representation task (e.g., abstract-syntax tree (AST), control-flow graph (CFG), data-flow graph (DFG), etc.).

The code mapper circuitry 815 learns a mapping relationship between individual source code elements and their representations. In some examples, the code mapper circuitry 815 generates the code representation based on the type of code representation identified by the code representation identifier circuitry 810 (e.g., AST, CFG, DFG, etc.). In examples disclosed herein, the code mapper circuitry 815 compiles the database of mappings between input source code/programs and their ASTs. In some examples, the code mapper circuitry 815 leverages debugging information to obtain the mapping(s). Debugging information contains mapping between locations in the input program and the corresponding program representations, shown in connection with FIG. 4. In some examples, the code mapper circuitry 815 generates canonicalized versions of program elements for use by the search initiator circuitry 830 when searching over the database D using input code snippets retrieved by the code retriever circuitry 825.

The database generator circuitry 820 generates a database of mappings between program(s) and corresponding program representation(s) of interest (e.g., AST, CFG, DFG, etc.). The database generator circuitry 820 stores input programs (P) and their corresponding program representations (e.g., program representations A) in a database (D), as described in connection with FIG. 3. As such, the database includes the set of pairs of P, A, where P represents an input program and A represents the program representation (i.e., input {(P, A)}). In examples disclosed herein, the database generator circuitry 820 stores the mapping between individual source code elements and their subtrees in the program AST. In some examples, the database generator circuitry 820 stores canonicalized versions of those elements together with their subtrees in A.

The code retriever circuitry 825 retrieves input code snippets. For example, actual input to an LLM is typically not a complete program, but instead the input is in snippets of a complete program (e.g., such as a for loop). As such, the code retriever circuitry 825 identifies the input code snippet to allow for the generation of a corresponding program representation based on the input code snippet. Searches for the snippet in the database D are initiated using the search initiator circuitry 830.

The search initiator circuitry 830 performs searching over the database of mappings using input code snippets to obtain the input code snippet representations (e.g., ASTs). In some examples, the search initiator circuitry 830 inputs code snippets into the database of mappings compiled using the database generator circuitry 820. The search initiator circuitry 830 determines whether the input code snippet is identifiable using the database of mappings. In some examples, the search initiator circuitry 830 uses a canonicalized version of code elements and their representations if an initial search does not yield an identification using the database of mappings. Once the search initiator circuitry 830 identifies the code snippet in the database D, the search initiator circuitry 830 outputs the corresponding program representation (e.g., AST-based subtree) based on the mappings generated by the code mapper circuitry 815.

The status identifier circuitry 835 performs assessment passes on the identified code representation and/or determines a code status and/or attribute (e.g., code can be vectorized, parallelized, etc.). For example, the status identifier circuitry 835 runs analysis passes on the AST-based subtrees, as described in connection with FIG. 5. For example, the status identifier circuitry 835 outputs a determination such as “The code can be parallelized if a and b are different arrays (non-aliased), but it cannot be parallelized if a and b are aliased.” However, any other type of determination can be made, including whether the code can be vectorized and/or parallelized.

The data storage 840 can be used to store any information associated with the code representation identifier circuitry 810, code mapper circuitry 815, database generator circuitry 820, code retriever circuitry 825, search initiator circuitry 830, and/or status identifier circuitry 835. The example data storage 840 of the illustrated example of FIG. 8 can be implemented by any memory, storage device and/or storage disc for storing data such as flash memory, magnetic media, optical media, etc. Furthermore, the data stored in the example data storage 840 can be in any data format such as binary data, comma delimited data, tab delimited data, structured query language (SQL) structures, image data, etc.

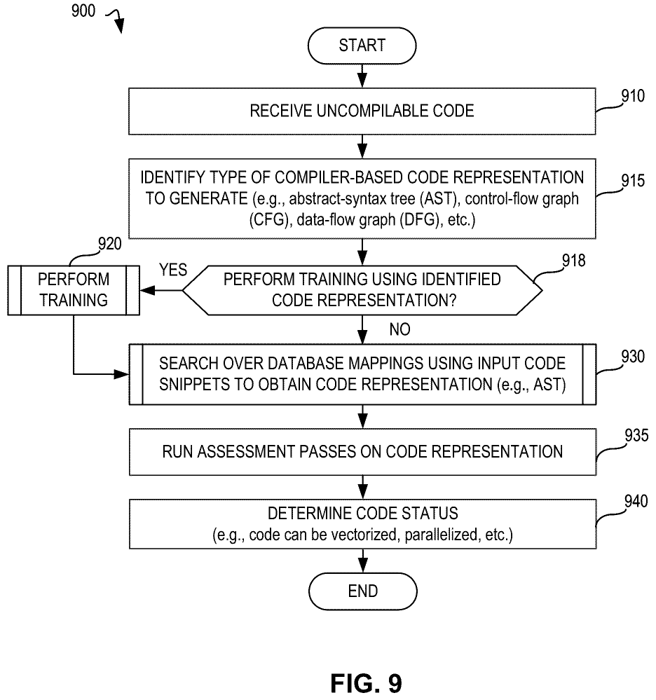

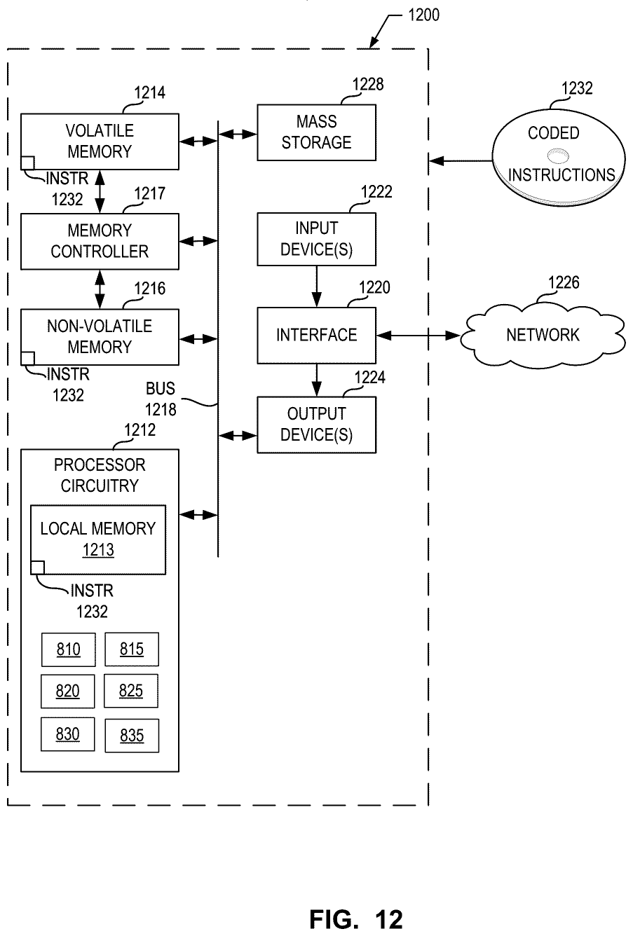

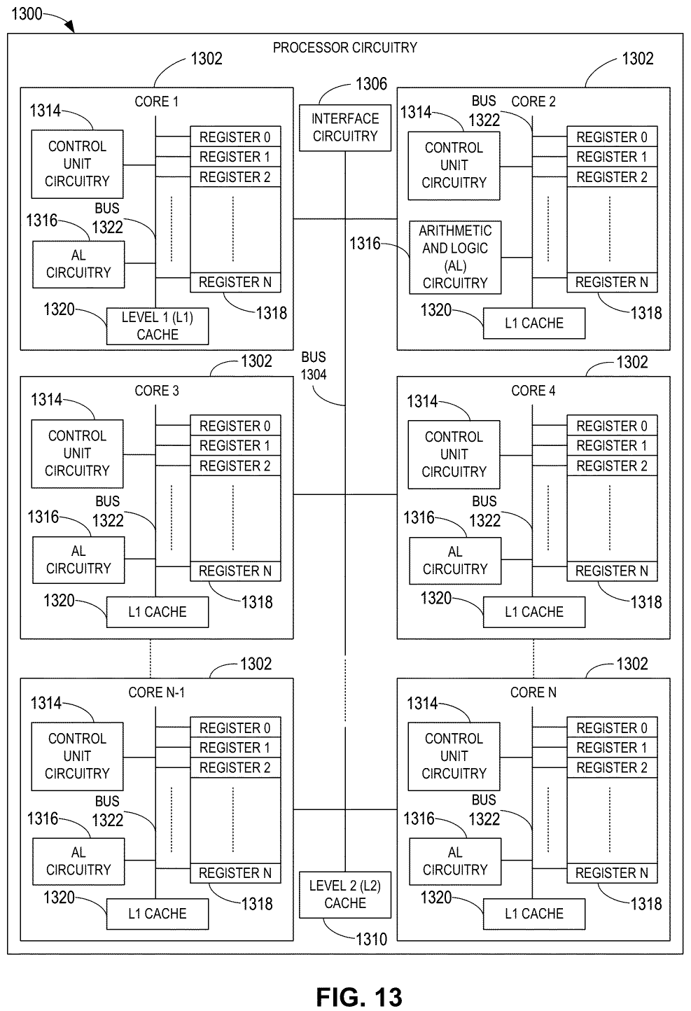

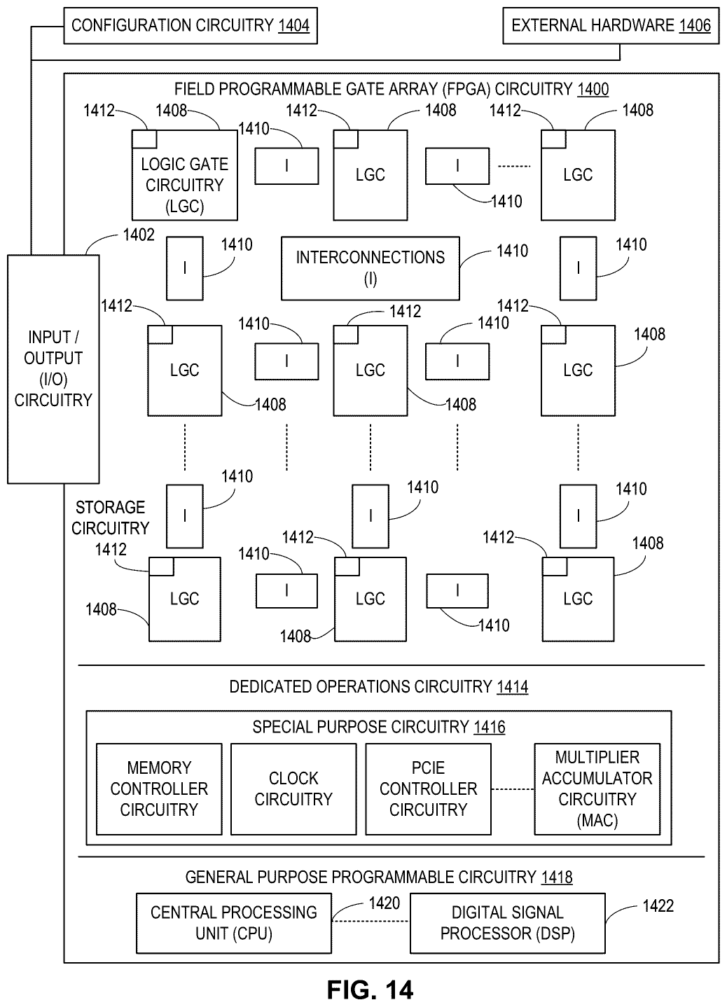

In some examples, the apparatus includes means for identifying a code representation. For example, the means for identifying a code representation may be implemented by code representation identifier circuitry 810. In some examples, the code representation identifier circuitry 810 may be instantiated by programmable circuitry such as the example programmable circuitry 1212 of FIG. 12. For instance, the code representation identifier circuitry 810 may be instantiated by the example microprocessor 1300 of FIG. 13 executing machine executable instructions such as those implemented by at least block 915 of FIG. 9. In some examples, the code representation identifier circuitry 810 may be instantiated by hardware logic circuitry, which may be implemented by an ASIC, XPU, or the FPGA circuitry 1400 of FIG. 14 structured to perform operations corresponding to the machine readable instructions. Additionally or alternatively, the code representation identifier circuitry 810 may be instantiated by any other combination of hardware, software, and/or firmware. For example, the code representation identifier circuitry 810 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for mapping code. For example, the means for mapping code may be implemented by code mapper circuitry 815. In some examples, the code mapper circuitry 815 may be instantiated by programmable circuitry such as the example programmable circuitry 1212 of FIG. 12. For instance, the code mapper circuitry 815 may be instantiated by the example microprocessor 1300 of FIG. 13 executing machine executable instructions such as those implemented by at least block 920 of FIG. 9. In some examples, the code mapper circuitry 815 may be instantiated by hardware logic circuitry, which may be implemented by an ASIC, XPU, or the FPGA circuitry 1400 of FIG. 14 structured to perform operations corresponding to the machine readable instructions. Additionally or alternatively, the code mapper circuitry 815 may be instantiated by any other combination of hardware, software, and/or firmware. For example, the code mapper circuitry 815 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

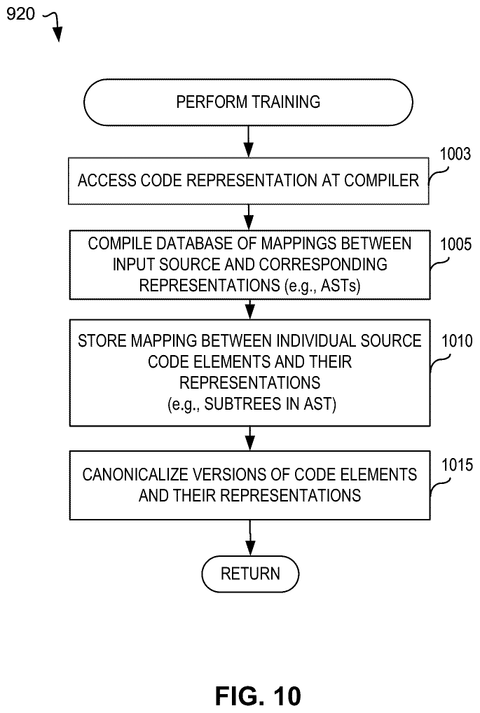

In some examples, the apparatus includes means for generating a database. For example, the means for generating a database may be implemented by database generator circuitry 820. In some examples, the database generator circuitry 820 may be instantiated by programmable circuitry such as the example programmable circuitry 1212 of FIG. 12. For instance, the database generator circuitry 820 may be instantiated by the example microprocessor 1300 of FIG. 13 executing machine executable instructions such as those implemented by at least block 1010 of FIG. 10. In some examples, the database generator circuitry 820 may be instantiated by hardware logic circuitry, which may be implemented by an ASIC, XPU, or the FPGA circuitry 1400 of FIG. 14 structured to perform operations corresponding to the machine readable instructions. Additionally or alternatively, the database generator circuitry 820 may be instantiated by any other combination of hardware, software, and/or firmware. For example, the database generator circuitry 820 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

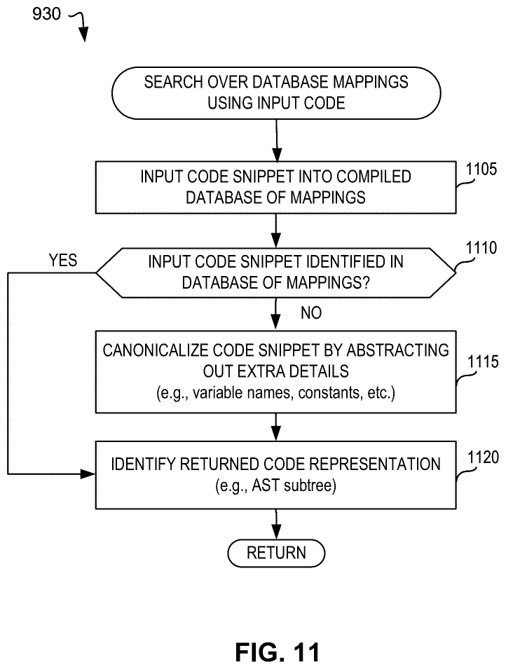

In some examples, the apparatus includes means for retrieving code. For example, the means for retrieving code may be implemented by code retriever circuitry 825. In some examples, the code retriever circuitry 825 may be instantiated by programmable circuitry such as the example programmable circuitry 1212 of FIG. 12. For instance, the code retriever circuitry 825 may be instantiated by the example microprocessor 1300 of FIG. 13 executing machine executable instructions such as those implemented by at least block 1105 of FIG. 11. In some examples, the code retriever circuitry 825 may be instantiated by hardware logic circuitry, which may be implemented by an ASIC, XPU, or the FPGA circuitry 1400 of FIG. 14 structured to perform operations corresponding to the machine readable instructions. Additionally or alternatively, the code retriever circuitry 825 may be instantiated by any other combination of hardware, software, and/or firmware. For example, the code retriever circuitry 825 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for initiating a search. For example, the means for initiating a search may be implemented by search initiator circuitry 830. In some examples, the search initiator circuitry 830 may be instantiated by programmable circuitry such as the example programmable circuitry 1212 of FIG. 12. For instance, the search initiator circuitry 830 may be instantiated by the example microprocessor 1300 of FIG. 13 executing machine executable instructions such as those implemented by at least block 1110 of FIG. 11. In some examples, the search initiator circuitry 830 may be instantiated by hardware logic circuitry, which may be implemented by an ASIC, XPU, or the FPGA circuitry 1400 of FIG. 14 structured to perform operations corresponding to the machine readable instructions. Additionally or alternatively, the search initiator circuitry 830 may be instantiated by any other combination of hardware, software, and/or firmware. For example, the search initiator circuitry 830 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying a status. For example, the means for identifying a status may be implemented by status identifier circuitry 835. In some examples, the status identifier circuitry 835 may be instantiated by programmable circuitry such as the example programmable circuitry 1212 of FIG. 12. For instance, the status identifier circuitry 835 may be instantiated by the example microprocessor 1300 of FIG. 13 executing machine executable instructions such as those implemented by at least block 940 of FIG. 9. In some examples, the status identifier circuitry 835 may be instantiated by hardware logic circuitry, which may be implemented by an ASIC, XPU, or the FPGA circuitry 1400 of FIG. 14 structured to perform operations corresponding to the machine readable instructions. Additionally or alternatively, the status identifier circuitry 835 may be instantiated by any other combination of hardware, software, and/or firmware. For example, the status identifier circuitry 835 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the code evaluator circuitry 502 is illustrated in FIG. 8, one or more of the elements, processes and/or devices illustrated in FIG. 8 may be combined, divided, re-arranged, omitted, eliminated and/or implemented in any other way. Further, the example code representation identifier circuitry 810, the example code mapper circuitry 815, the example database generator circuitry 820, the example code retriever circuitry 825, the example search initiator circuitry 830, the example status identifier circuitry 835 and/or, more generally, the example code evaluator circuitry 502 of FIG. 8 may be implemented by hardware, software, firmware and/or any combination of hardware, software and/or firmware. Thus, for example, any of the example code representation identifier circuitry 810, the example code mapper circuitry 815, the example database generator circuitry 820, the example code retriever circuitry 825, the example search initiator circuitry 830, the example status identifier circuitry 835 and/or, more generally, the example code evaluator circuitry 502 of FIG. 8 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the code evaluator circuitry 502 of FIG. 8 may include one or more elements, processes, and/or devices in addition to, or instead of, those illustrated in FIG. 8, and/or may include more than one of any or all of the illustrated elements, processes and devices.

Flowcharts representative of example machine readable instructions, which may be executed by programmable circuitry to implement and/or instantiate the code evaluator circuitry 502 of FIG. 8 and/or representative of example operations which may be performed by programmable circuitry to implement and/or instantiate the code evaluator circuitry 502 of FIG. 8, are shown in FIGS. 9-11. The machine readable instructions may be one or more executable programs or portion(s) of one or more executable programs for execution by programmable circuitry, such as the programmable circuitry 1212 shown in the example processor platform 1200 discussed below in connection with FIG. 12 and/or may be one or more function(s) or portion(s) of functions to be performed by the example programmable circuitry (e.g., an FPGA) discussed below in connection with FIGS. 13 and/or 14. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 9-11, many other methods of implementing the example code evaluator circuitry 502 of FIG. 8 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, and/or activities, the phrase “at least one of A and B” is intended to refer to implementations including any of (1) at least one A, (2) at least one B, or (3) at least one A and at least one B. Similarly, as used herein in the context of describing the performance or execution of processes, instructions, actions, and/or activities, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 9 is a flowchart representative of example machine readable instructions and/or example operations 900 that may be executed, instantiated, and/or performed by programmable circuitry to implement the example code evaluator circuitry 502 of FIG. 8. The machine readable instructions and/or the operations 900 of FIG. 9 begin at block 910, at which the code representation identifier circuitry 810 receives uncompilable code. The code representation identifier circuitry 810 proceeds to identify the type of compiler-based code representation to generate, at block 915. In some examples, the code representation identifier circuitry 810 determines whether the code representation should be in the form of an abstract-syntax tree (AST), a control-flow graph (CFG), and/or a data-flow graph (DFG). For example, an AST serves as a representation of the abstract syntactic structure of text (e.g., source code) written in a formal language, such that each node of the tree denotes a construct occurring in the text. Separately, CFGs present a representation of all paths that might be traversed through a program during execution and DFGs present a representation of data flow through a program. The code representation identifier circuitry 810 determines whether training of a neural network is needed to obtain code representation(s), at block 918. If training has not been performed, the code mapper circuitry 815 performs training, at block 920, as described in more detail in connection with FIG. 10. For example, the code mapper circuitry 815 generates mappings between the input source code and corresponding program representations (e.g., ASTs). Based on the code representation(s) and input code snippet(s), the search initiator circuitry 830 searches over a database of mappings using the input code snippets to obtain the code representation (e.g., ASTs), at block 930. For example, the search initiator circuitry 830 identifies returned code representations, as described in connection with FIG. 11. Once the returned code representations are identified, the status identifier circuitry 835 runs assessment passes on the code representations, at block 935. For example, the search initiator circuitry 830 performs assessment passes on the identified code representation and determines a code status and/or attribute of the code, at block 940. For example, the search initiator circuitry 830 determines whether the input code can be vectorized and/or parallelized.

FIG. 10 is a flowchart representative of example machine readable instructions and/or example operations 1000 that may be executed, instantiated, and/or performed by programmable circuitry to implement the code evaluator circuitry 502 of FIG. 8 to perform training using identified code representation(s). The machine readable instructions and/or the operations 1000 of FIG. 10 begin at block 1003, when the code mapper circuitry 815 accesses the code representation at a compiler. The code mapper circuitry 815 compiles a database of mappings between the input source code and corresponding program representations (e.g., ASTs), at block 1005. The database generator circuitry 820 proceeds to store the generated mappings between individual source code elements and their representations, at block 1010. For example, the program representations can include AST-based subtrees. In some examples, the database generator circuitry 820 also stores canonicalized versions of the code elements and their representations, at block 1015. For example, the code mapper circuitry 815 generates canonicalized versions of program elements for use by the search initiator circuitry 830 when searching over the database D using input code snippets, as described in connection with FIG. 11.

FIG. 11 is a flowchart representative of example machine readable instructions and/or example operations 1100 that may be executed, instantiated, and/or performed by programmable circuitry to implement the code evaluator circuitry 502 of FIG. 8 to search over database mappings using input code snippets in accordance with teachings disclosed herein. The machine readable instructions and/or the operations 1100 of FIG. 11 begin at block 1105, when the search initiator circuitry 830 inputs code snippets into the compiled database of mappings. If the search initiator circuitry 830 identifies the input code snippet in the database of mappings, at block 1110, the search initiator circuitry 830 identifies the returned code representation, at block 1120. If the search initiator circuitry 830 does not identify the input code snippet in the database of mappings, at block 1110, the search initiator circuitry 830 canonicalizes the code snippet by abstracting out additional details (e.g., variable names, constants, etc.), at block 1115. As such, the search initiator circuitry 830 can search the database of mappings using the canonicalized version(s) of the input code snippet to identify a returned code representation (e.g., AST subtree), at block 1120.

FIG. 12 is a block diagram of an example programmable circuitry platform 1200 structured to execute and/or instantiate the example machine-readable instructions and/or the example operations of FIGS. 9-11 to implement the example code evaluator circuitry 502 of FIG. 8. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs microprocessors, CPUs, GPUs, DSPs, and/or microcontrollers from any desired family or manufacturer. The programmable circuitry 1212 may be implemented by one or more semiconductor based (e.g., silicon based) devices. In this example, the processor circuitry 1212 implements the code representation identifier circuitry 810, the code mapper circuitry 815, the database generator circuitry 820, the code retriever circuitry 825, the search initiator circuitry 830, and the status identifier circuitry 835.

The programmable circuitry 1212 of the illustrated example includes a local memory 1213 (e.g., a cache, registers, etc.). The programmable circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output devices 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1200 of the illustrated example also includes one or more mass storage devices 1228 to store software and/or data. Examples of such mass storage devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1232, which may be implemented by the machine readable instructions of FIGS. 9-11, may be stored in the mass storage device 1228, in the volatile memory 1214, in the non-volatile memory 1216, and/or on at least one non-transitory computer readable storage medium such as a CD or DVD which may be removable.

FIG. 13 is a block diagram of an example implementation of the programmable circuitry 1212 of FIG. 12. In this example, the programmable circuitry 1212 of FIG. 12 is implemented by a microprocessor 1300. For example, the microprocessor 1300 may be a general purpose microprocessor (e.g., general purpose microprocessor circuitry). The microprocessor 1300 executes some or all of the machine readable instructions of the flowcharts of FIGS. 9-11 to effectively instantiate the circuitry of FIG. 8 logic circuits to perform the operations corresponding to those machine readable instructions. In some such examples, the circuitry of FIG. 8 is instantiated by the hardware circuits of the microprocessor 1300 in combination with the instructions. For example, the microprocessor 1300 may implement multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 9-11.

The cores 1302 may communicate by a first example bus 1304. In some examples, the first bus 1304 may implement a communication bus to effectuate communication associated with one(s) of the cores 1302. For example, the first bus 1304 may implement at least one of an Inter-Integrated Circuit (I2C) bus, a Serial Peripheral Interface (SPI) bus, a PCI bus, or a PCIe bus. Additionally or alternatively, the first bus 1304 may implement any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2_cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the L1 cache 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer-based operations. In other examples, the AL circuitry 1316 also performs floating-point operations. In yet other examples, the AL circuitry 1316 may include first AL circuitry that performs integer-based operations and second AL circuitry that performs floating point operations. In some examples, the AL circuitry 1316 may be referred to as an Arithmetic Logic Unit (ALU).

The registers 1318 are semiconductor-based structures to store data and/or instructions such as results of one or more of the operations performed by the AL circuitry 1316 of the corresponding core 1302. For example, the registers 1318 may include vector register(s), SIMD register(s), general purpose register(s), flag register(s), segment register(s), machine specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure including distributed throughout the core 1302 to shorten access time. The second bus 1322 may be implemented by at least one of an I2C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages.

The microprocessor 1300 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1300, in the same chip package as the microprocessor 1300 and/or in one or more separate packages from the microprocessor 1300.

FIG. 14 is a block diagram of another example implementation of the programmable circuitry of FIG. 12. In this example, the programmable circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine readable instructions represented by the flowcharts of FIGS. 9-11 but whose interconnections and logic circuitry are fixed once fabricated), the FPGA circuitry 1400 of the example of FIG. 14 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 9-11. In particular, the FPGA 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 9-11. As such, the FPGA circuitry 1400 may be configured and/or structured to effectively instantiate some or all of the operations/functions corresponding to the machine readable instructions of the flowcharts of FIGS. 9-11 as dedicated logic circuits to perform the operations/functions corresponding to those software instructions in a dedicated manner analogous to an ASIC. Therefore, the FPGA circuitry 1400 may perform the operations/functions corresponding to the some or all of the machine readable instructions of FIGS. 9-11 faster than the general-purpose microprocessor can execute the same.

In the example of FIG. 14, the FPGA circuitry 1400 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain a binary file, which may be implemented by a bit stream, data, and/or machine-readable instructions, to configure the FPGA circuitry 1400, or portion(s) thereof. In some such examples, the configuration circuitry 1404 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine readable instructions of FIGS. 9-11 and/or other desired operations. The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the programmable circuitry 1212 of FIG. 12, many other approaches are contemplated. For example, FPGA circuitry may include an on-board CPU, such as one or more of the example CPU 1420 of FIG. 14. Therefore, the programmable circuitry 1212 of FIG. 12 may additionally be implemented by combining at least the example microprocessor 1300 of FIG. 13 and the example FPGA circuitry 1400 of FIG. 14. In some such hybrid examples, one or more cores 1402 of FIG. 14 may execute a first portion of the machine readable instructions represented by the flowchart(s) of FIGS. 9-11 to perform first operation(s)/function(s), the FPGA circuitry 1400 of FIG. 14 may be configured and/or structured to perform second operation(s)/function(s) corresponding to a second portion of the machine readable instructions represented by the flowcharts of FIGS. 9-11, and/or an ASIC may be configured and/or structured to perform third operation(s)/function(s) corresponding to a third portion of the machine readable instructions represented by the flowcharts of FIGS. 9-11.

It should be understood that some or all of the circuitry of FIG. 8 may, thus, be instantiated at the same or different times. For example, same and/or different portion(s) of the microprocessor 1300 of FIG. 13 may be programmed to execute portion(s) of machine-readable instructions at the same and/or different times. In some examples, same and/or different portion(s) of the FPGA circuitry 1400 of FIG. 14 may be configured and/or structured to perform operations/functions corresponding to portion(s) of machine-readable instructions at the same and/or different times.

In some examples, some or all of the circuitry of FIG. 8 may be instantiated, for example, in one or more threads executing concurrently and/or in series. For example, the microprocessor 1300 of FIG. 13 may execute machine readable instructions in one or more threads executing concurrently and/or in series. In some examples, the FPGA circuitry 1400 of FIG. 14 may be configured and/or structured to carry out operations/functions concurrently and/or in series. Moreover, in some examples, some or all of the circuitry of FIG. 8 may be implemented within one or more virtual machines and/or containers executing on the microprocessor 1300 of FIG. 13.

In some examples, the programmable circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the programmable circuitry 1212 of FIG. 12 which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

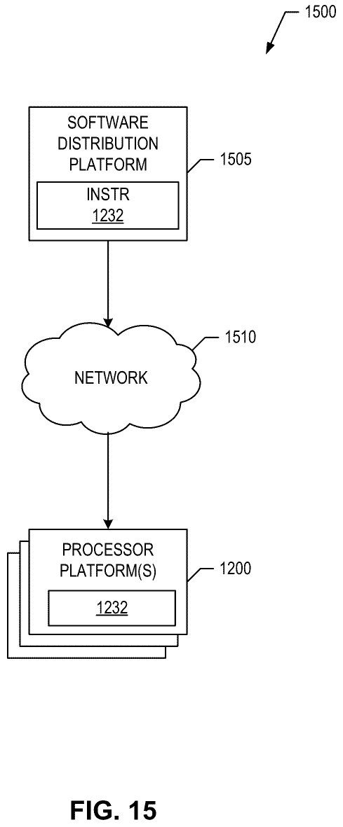

A block diagram illustrating an example software distribution platform 1505 to distribute software such as the example machine readable instructions 1232 of FIG. 12 to other hardware devices (e.g., hardware devices owned and/or operated by third parties from the owner and/or operator of the software distribution platform) is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232, which may correspond to the example machine readable instructions of FIGS. 9-11, as described above. The one or more servers of the example software distribution platform 1505 are in communication with an example network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions of FIGS. 9-11, may be downloaded to the example programmable circuitry platform 1200, which is to execute the machine readable instructions 1232 to implement the code evaluator circuitry 502. In some examples, one or more servers of the software distribution platform 1505 periodically offer, transmit, and/or force updates to the software (e.g., the example machine readable instructions 1232 of FIG. 12) to ensure improvements, patches, updates, etc., are distributed and applied to the software at the end user devices. Although referred to as software above, the distributed “software” could alternatively be firmware.

From the foregoing, it will be appreciated that example systems, methods, apparatus, and articles of manufacture have been disclosed that combine code large language models (LLMs) with compilers to add program reasoning capabilities to code LLMs. Methods and apparatus disclosed herein can be deployed as a part of a software suite or as a standalone Software-as-a-Service (SaaS) model (e.g., optimization-as-a-service) to assist developers with complex problems. In examples disclosed herein, LLMs can solve complex programming problems and improve overall programming efficiency. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for combining code large language models (LLMs) with compilers are disclosed herein. Further examples and combinations thereof include the following:

Example 1 includes an apparatus comprising interface circuitry, machine readable instructions, and programmable circuitry to at least one of instantiate or execute the machine readable instructions to receive an input source code by a code large language model (LLM), generate one or more code representations of the input source code, analyze the one or more code representations of the input source code, and compile the one or more code representations of the input source code into one or more computer executable instructions.

Example 2 includes the apparatus of example 1, wherein the programmable circuitry is to analyze the one or more code representations of the input source code by executing the machine readable instructions to generate a code representation mapping based on the input source code and the one or more code representations, access the input source code, and determine an attribute of the input source code based on at least one code representation identified using the code representation mapping.

Example 3 includes the apparatus of example 2, wherein the at least one code representation is an abstract-syntax tree (AST), a control-flow graph (CFG), or a data-flow graph (DFG).

Example 4 includes the apparatus of example 2, wherein the programmable circuitry is to store the code representation mapping, the code representation mapping corresponding to a mapping between an individual source code element and representations of the source code element.

Example 5 includes the apparatus of example 4, wherein the programmable circuitry is to canonicalize the individual source code element and the representation of the source code element.

Example 6 includes the apparatus of example 5, wherein the source code element includes at least one of a function, loop, statement, or variable.

Example 7 includes the apparatus of example 1, wherein the input source code is at least one of a vectorizable code or a parallelizable code.

Example 8 includes a method comprising receiving an input source code by a code large language model (LLM), generating one or more code representations of the input source code, analyzing the one or more code representations of the input source code, and compiling the one or more code representations of the input source code into one or more computer executable instructions.

Example 9 includes the method of example 8, further including generating a code representation mapping based on the input source code and the one or more code representations, accessing the input source code, and determining an attribute of the input source code based on at least one code representation identified using the code representation mapping.

Example 10 includes the method of example 9, wherein the at least one code representation is an abstract-syntax tree (AST), a control-flow graph (CFG), or a data-flow graph (DFG).

Example 11 includes the method of example 9, further including storing the code representation mapping, the code representation mapping corresponding to a mapping between an individual source code element and representations of the source code element.

Example 12 includes the method of example 11, further including canonicalizing the individual source code element and the representation of the source code element.

Example 13 includes the method of example 12, wherein the source code element includes at least one of a function, loop, statement, or variable.

Example 14 includes the method of example 8, wherein the input source code is at least one of a vectorizable code or a parallelizable code.

Example 15 includes a non-transitory machine readable storage medium comprising instructions to cause programmable circuitry to at least receive an input source code by a code large language model (LLM), generate one or more code representations of the input source code, analyze the one or more code representations of the input source code, and compile the one or more code representations of the input source code into one or more computer executable instructions.

Example 16 includes the non-transitory machine readable storage medium of example 15, wherein the instructions are to cause the programmable circuitry to generate a code representation mapping based on the input source code and the one or more code representations, access the input source code, and determine an attribute of the input source code based on at least one code representation identified using the code representation mapping.

Example 17 includes the non-transitory machine readable storage medium of example 16, wherein the instructions are to cause the programmable circuitry to store the code representation mapping, the code representation mapping corresponding to a mapping between an individual source code element and representations of the source code element.

Example 18 includes the non-transitory machine readable storage medium of example 17, wherein the instructions are to cause the programmable circuitry to canonicalize the individual source code element and the representation of the source code element.

Example 19 includes the non-transitory machine readable storage medium of example 18, wherein the source code element includes at least one of a function, loop, statement, or variable.

Example 20 includes the non-transitory machine readable storage medium of example 15, wherein the input source code is at least one of a vectorizable code or a parallelizable code.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
interface circuitry;
machine readable instructions; and
programmable circuitry to at least one of instantiate or execute the machine readable instructions to:
receive an input source code by a code large language model (LLM);
generate one or more code representations of the input source code;
analyze the one or more code representations of the input source code; and
compile the one or more code representations of the input source code into one or more computer executable instructions.

2. The apparatus of claim 1, wherein the programmable circuitry is to analyze the one or more code representations of the input source code by executing the machine readable instructions to:
generate a code representation mapping based on the input source code and the one or more code representations;
access the input source code; and
determine an attribute of the input source code based on at least one code representation identified using the code representation mapping.

3. The apparatus of claim 2, wherein the at least one code representation is an abstract-syntax tree (AST), a control-flow graph (CFG), or a data-flow graph (DFG).

4. The apparatus of claim 2, wherein the programmable circuitry is to store the code representation mapping, the code representation mapping corresponding to a mapping between an individual source code element and representations of the source code element.

5. The apparatus of claim 4, wherein the programmable circuitry is to canonicalize the individual source code element and the representation of the source code element.

6. The apparatus of claim 5, wherein the source code element includes at least one of a function, loop, statement, or variable.

7. The apparatus of claim 1, wherein the input source code is at least one of a vectorizable code or a parallelizable code.

8. A method comprising:
receiving an input source code by a code large language model (LLM);
generating one or more code representations of the input source code;
analyzing the one or more code representations of the input source code; and
compiling the one or more code representations of the input source code into one or more computer executable instructions.

9. The method of claim 8, further including:
generating a code representation mapping based on the input source code and the one or more code representations;
accessing the input source code; and
determining an attribute of the input source code based on at least one code representation identified using the code representation mapping.

10. The method of claim 9, wherein the at least one code representation is an abstract-syntax tree (AST), a control-flow graph (CFG), or a data-flow graph (DFG).

11. The method of claim 9, further including storing the code representation mapping, the code representation mapping corresponding to a mapping between an individual source code element and representations of the source code element.

12. The method of claim 11, further including canonicalizing the individual source code element and the representation of the source code element.

13. The method of claim 12, wherein the source code element includes at least one of a function, loop, statement, or variable.

14. The method of claim 8, wherein the input source code is at least one of a vectorizable code or a parallelizable code.

15. A non-transitory machine readable storage medium comprising instructions to cause programmable circuitry to at least:
receive an input source code by a code large language model (LLM);
generate one or more code representations of the input source code;
analyze the one or more code representations of the input source code; and
compile the one or more code representations of the input source code into one or more computer executable instructions.

16. The non-transitory machine readable storage medium of claim 15, wherein the instructions cause the programmable circuitry to:
generate a code representation mapping based on the input source code and the one or more code representations;
access the input source code; and
determine an attribute of the input source code based on at least one code representation identified using the code representation mapping.

17. The non-transitory machine readable storage medium of claim 16, wherein the instructions cause the programmable circuitry to store the code representation mapping, the code representation mapping corresponding to a mapping between an individual source code element and representations of the source code element.

18. The non-transitory machine readable storage medium of claim 17, wherein the instructions cause the programmable circuitry to canonicalize the individual source code element and the representation of the source code element.

19. The non-transitory machine readable storage medium of claim 18, wherein the source code element includes at least one of a function, loop, statement, or variable.

20. The non-transitory machine readable storage medium of claim 15, wherein the input source code is at least one of a vectorizable code or a parallelizable code.
